(19) United States
(12) Patent Application Publication
(10) Pub. No.: US 2005/0228761 A1
(43) Pub. Date: Oct. 13, 2005

(54) Manifesting mail for legal electronic proof of induction/acceptance

(75) Inventors: Erik D.N. Monsen, Shelton, CT (US); Ronald P. Sansone, Weston, CT (US); Ian A. Siveyer, Monroe, CT (US)

Correspondence Address: Pitney Bowes Inc.;Intellectual Property and Technology Law Dept., 35 Waterview Drive, P.O. Box 3000, Shelton, CT, 06484, US

(73) Assignee: Pitney Bowes Incorporated, Stamford, CT (US)

(21) Appl. No.: 10/814,420

(22) Filed: Mar. 31, 2004

(51) Int. Cl. G06F 17/00

(52) U.S. Cl. 705/401

(57) ABSTRACT

A method for electronic proof of induction/acceptance for manifested special service mail. The foregoing may be accomplished by having the post office notify the mailer's postage meter of the induction/acceptance of the manifested mail pieces when the post office scans the manifest and mail pieces at the beginning of the delivery process.

### CROSS REFERENCE TO RELATED APPLICATIONS

Reference is made to commonly assigned co-pending patent application Attorney Docket No. F-800 filed simultaneously herewith, entitled “Special Service Mail Electronic Uploads With Automatic Return Of Legal Proof Of Induction/Acceptance” in the names of Erik D. N. Monsen, Ronald P. Sansone and Ian A. Siveyer.

### FIELD OF THE INVENTION

The invention relates generally to the field of mailing and, more particularly, to the field of inducting manifest mail into a mail stream.

### BACKGROUND OF THE INVENTION

The United States Postal Service (hereinafter “USPS”) currently handles large volumes of normal mail, i.e., first class mail, standard mail and third class mail. However, when it comes to specialty mail, i.e., priority mail, certified mail and registered mail, the USPS uses gummed service stickers and forms to indicate and process the specialty mail. The use of gummed service stickers and completion of forms by hand is unnecessary, time-consuming, error prone and raises the expense for those receiving these services. Furthermore, the use of some services, i.e., certified mail, registered mail, and the obtaining of a certificate of mailing, requires the mailer to physically deliver the mail piece to a postal clerk at the counter of the post office.

Currently the USPS is utilizing a manifest mailing system. The manifest mailing system is a postage payment system that enables the USPS to accept and verify permit imprint mailings that contain non-identical weight and/or non-identical rate pieces of the same mail class and same mail processing category. The mail pieces are prepared by the mailer according to certain standards and require a mailer prepared manifest.

The mailer brings the manifest and the manifested mail pieces to a postal facility where a USPS employee checks the information on the manifest to insure that the manifest accurately represents the mail pieces being inducted into the USPS. Then the mailer pays the USPS, i.e., by check for mailing the manifested items, and the USPS employee stamps a copy of the manifest for the mailer to retain.

A problem with the foregoing manifest mailing system is that there is no record of each specific mail piece that was received by the USPS. There is only a record that the USPS received a certain number of mail pieces having a certain aggregate weight.

An additional problem with the foregoing is that the USPS is not open for business twenty-four hours a day, seven days a week, and mailers are unable to obtain proof of mailing every hour of the day.

### SUMMARY OF THE INVENTION

The present invention overcomes the disadvantages of the prior art by providing an inexpensive and time-saving method for electronic proof of induction/acceptance for manifested special service mail. The invention permits a mailer to obtain legal proof of induction/acceptance of many mail pieces without requiring the mailer to bring the mail piece to the post office. This invention also reduces the number of trips that a mailer has to make to the post office, and the time that a mailer has to wait in line at the post office counter. The foregoing may be accomplished by having a mailer prepare a manifest. The manifest lists information about individual mail pieces including the USPS special service used, a unique number that specifically identifies each mail piece, i.e., the mail piece tracking number, the destination zip code, the total number of manifested mail pieces, and a request for a certificate of induction for some or all of the mail pieces listed in the manifest, etc. The USPOS also notifies the mailer's postage meter and/or a designated web site, and/or an e-mail address of the induction/acceptance of the mail pieces when the post office scans the manifest and mail pieces at the beginning of the delivery process.

### BRIEF DESCRIPTION OF THE DRAWING

FIG. 1 is a block diagram showing the overall flow of the method and system for providing proof of mailing a mail piece utilizing a postage meter or personal computer postage meter;

FIG. 2A is a flow chart describing an information gathering procedure at a postage meter for obtaining proof of mailing from a postage meter that uses manual recipient address entry;

FIG. 2B is a flow chart describing an information gathering procedure at the postage meter for obtaining proof of mailing that uses optical character recipient address entry;

FIG. 3 is a flow chart describing the proof of mailing process with regard to a Postage By Phones data center;

FIGS. 4A and 4B are drawings of mail piece 11 of FIG. 1 addressed to different people in greater detail;

FIG. 5A is a drawing of a certificate of induction indicating that a scanner of the post office has read unique identification code 15 on mail piece 11, which unique identification code 15 indicates that mail piece 11 has entered the delivery process;

FIG. 5B is a drawing of a certificate of non-induction indicating that a scanner of the post office has not read unique identification code 15 on mail piece 11 indicating that mail piece 11 has not entered the delivery process;

FIG. 5C is a drawing of a certificate of induction indicating that a scanner of the post office has read manifest 100;

FIG. 6 is a drawing of a manifest;

FIG. 7 is a drawing of a plurality of mail pieces being bound by a manifest; and

FIG. 8 is a drawing of a top view of a mail tray 120 containing mail pieces 11 and a manifest 50 (not shown) in pocket 121.

### DETAILED DESCRIPTION

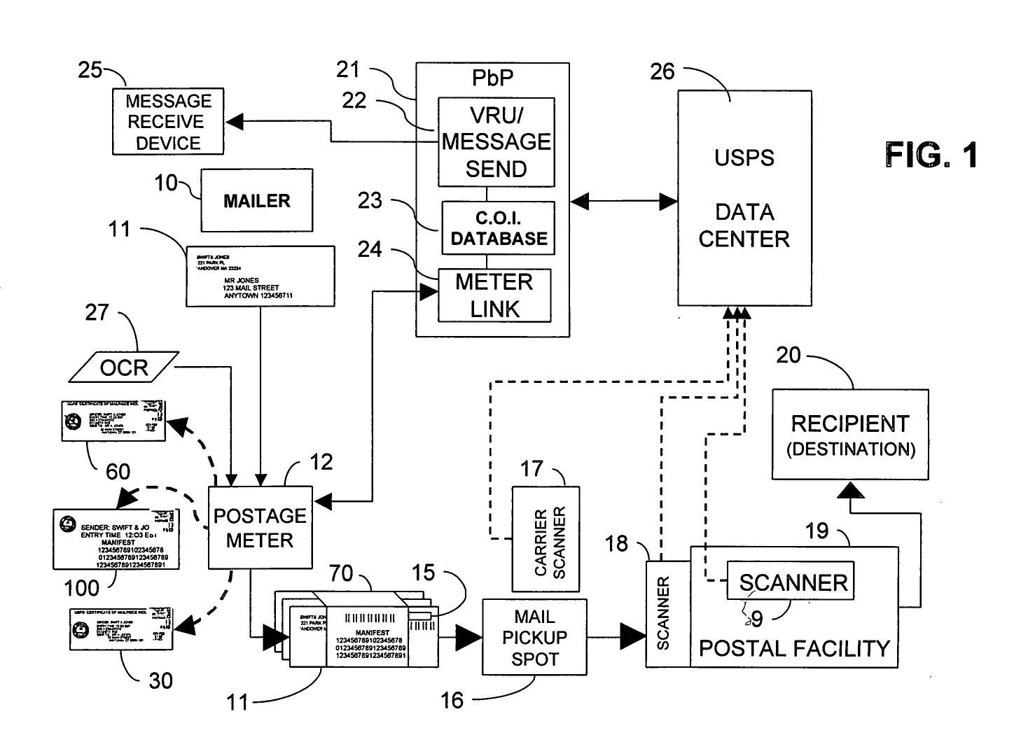

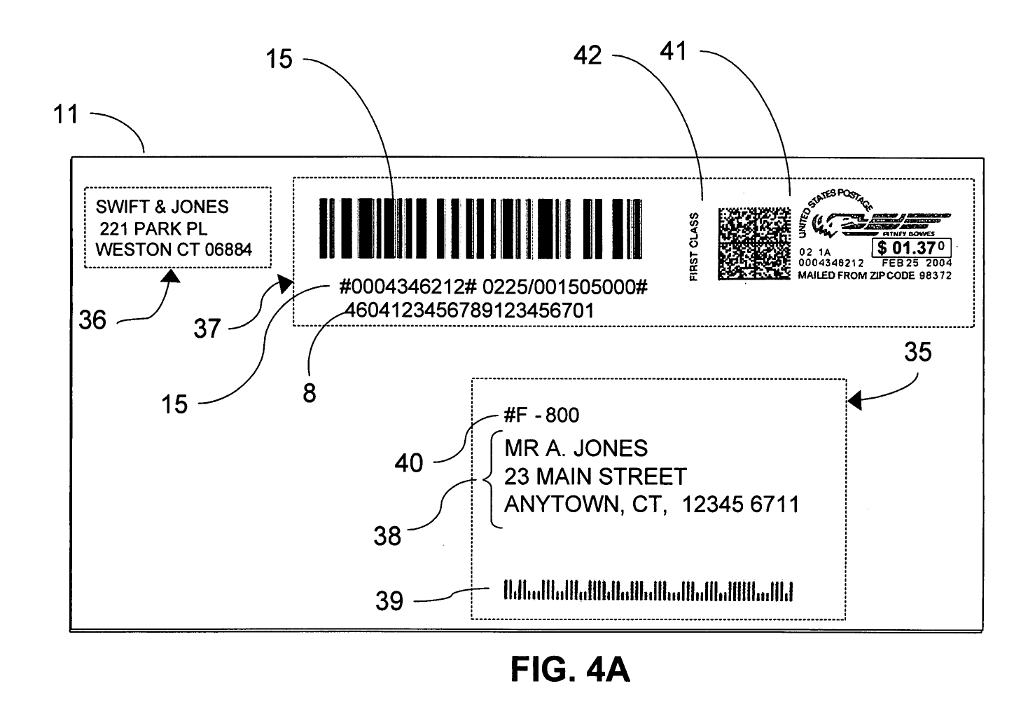

FIG. 1 shows a mailer 10 who is going to mail a mail piece 11. The mailer 10 uses a postage meter 12 to pay the postage for mailing mail piece 11. Meter 12 may be an electronic meter manufactured by Pitney Bowes Inc. of 1 Elmcroft Road, Stamford, Conn., or a personal computer postage meter system with a secure data storage device manufactured by Pitney Bowes Inc. of 1 Elmcroft Road, Stamford, Conn. An optical character recognition scanner 27 reads the recipient's address on mail piece 11, or the user of meter 12 enters the recipient's address into meter 12. Mail piece 11 contains a unique identification code 15, i.e., the meter serial number and the date and time that a postal indicia was affixed to mail piece 11 (mail piece 11 is more fully described in the descriptions of FIGS. 4A and 4B). Unique identification code 15 may include the above with or without a United States Special Service Tracking Number 8, which is a unique identification code that is described in the description of FIGS. 4A-4B. Unique codes 8 and 15 may also be contained in a radio frequency identification tag. The United States Special Service Tracking Number 8 may be assigned to mailers by the USPS, created by meter 12, placed on labels provided by the USPS, or created by meter 12 or data center 21.

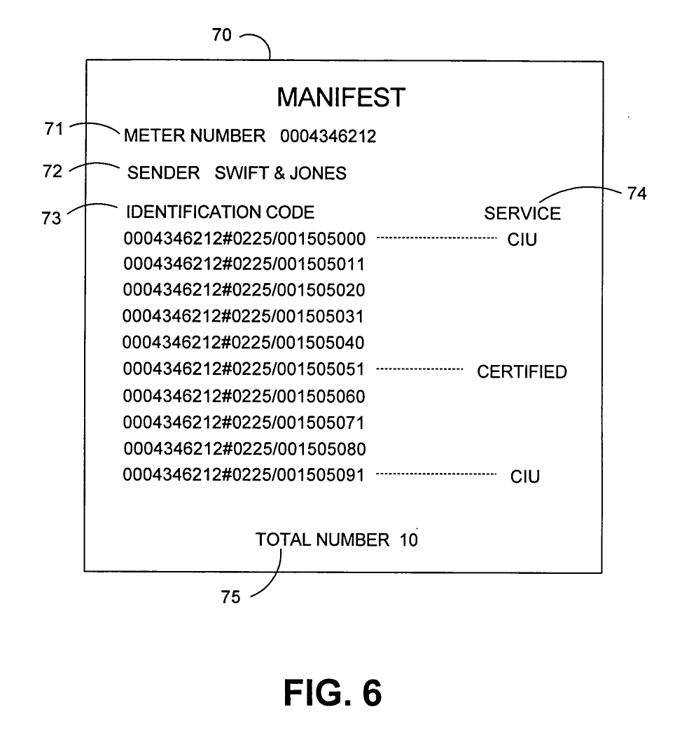

Meter 12 places adequate postage on mail pieces 11 and prints a manifest 70 (FIG. 7). The mailer 10 binds mail pieces 11 with manifest 70 and submits manifest 70 along with mail pieces 11 to a USPS mail pick up spot 16. A hand-held scanner 17 may read unique manifest 70 at mail pick up spot 16, or a scanner 18 may read manifest 70 at entry USPS facility 19. A scanner 9 at entry postal facility 19 may read the identification codes 15 on mail pieces 11. Facility 19 will process mail piece 11 and deliver it to the recipient's destination 20.

Meter 12 is coupled to a data processing center such as Pitney Bowes Postage By Phone data center 21. Data center 21 contains a message sending device 22, i.e., voice response unit, telephone, facsimile, e-mail, etc., a certificate of induction process/database 23, and a meter link 24. Meter 12 is coupled to messaging receiving device 25, i.e., telephone, facsimile, e-mail. Data center 21 is also coupled to USPS data center 26.

A plurality of meters 12 may upload the unique identification code 15 that is placed on a specific mail piece 11 to meter link 24. Meter link 24 transfers the identification codes to certificate of induction process/database 23. From time to time, process/database 23 is used to produce a batch file from identification codes 15 that it has received from a plurality of meters 12. The batch file is transmitted to USPS data center 26.

After scanners 17 and/or 18 read manifest 70, the information contained in manifest 70 is sent to USPS data center 26. Data center 26 stores the information contained in manifest 70.

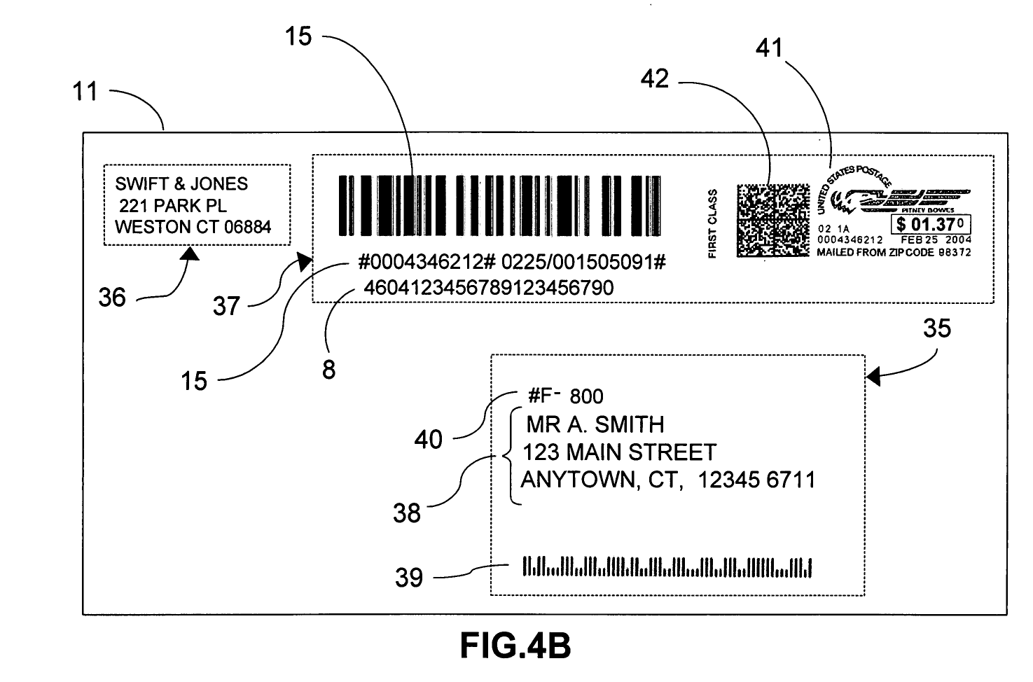

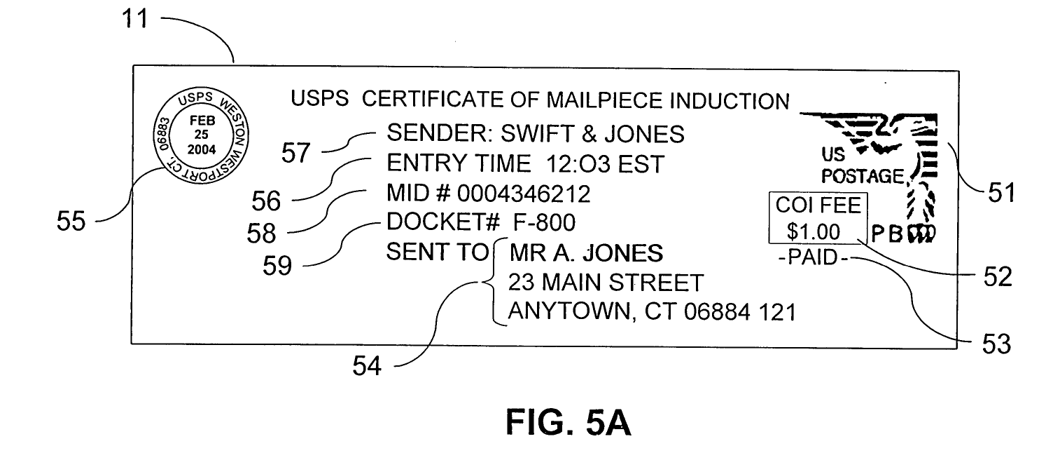

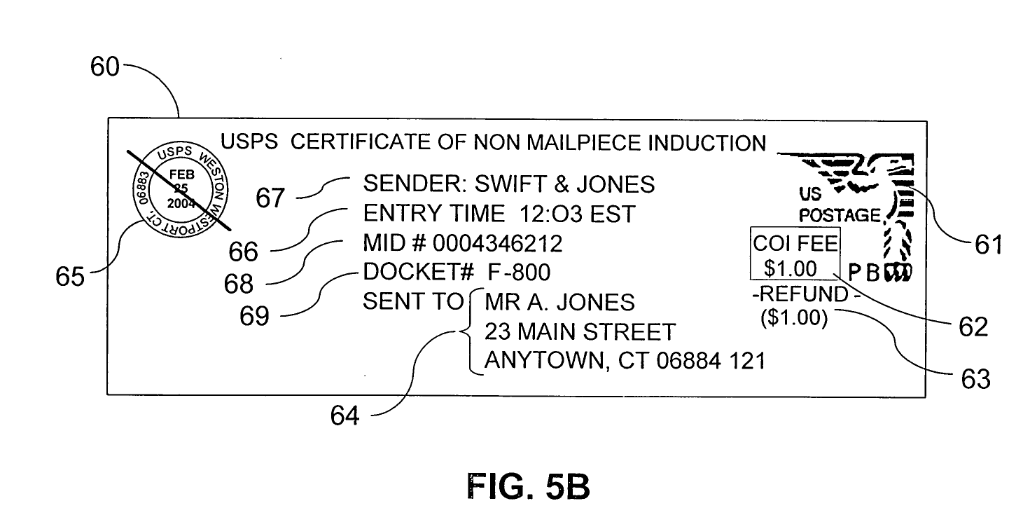

After scanner 9 reads identification codes 15, identification codes 15 are processed and transmitted to USPS data center 26. Data center 26 stores the identification codes 15 that it receives from scanners 17 and/or 18, and performs a matching process with the identification codes 15 that it receives from certificate of induction process/database 23. A batch file of those matches is produced by data center 26 and is sent to process/database 23. Then, each matched identification code 15 produces a digitally signed message that indicates the USPS has noted the entry of the mail piece 11 that has identification code 15 affixed thereto. The digitally signed message is sent to meter 12 where it is stored in the meter's non-volatile memory awaiting mailer's 10 command to print a certificate of induction 30, which will be described in the description of FIG. 5A, on a paper tape. Meter 12 may also print on a paper tape (not shown) a certificate of non-induction 60 which will be described in the description of FIG. 5B. Process/data base 23 is coupled to messaging sending device 22 to provide and store a message announcing the arrival of a certificate of induction 30 being available at meter 12. The message may also be sent to the user of meter 12 via messaging device 25, i.e., e-mail, facsimile, telephone, etc.

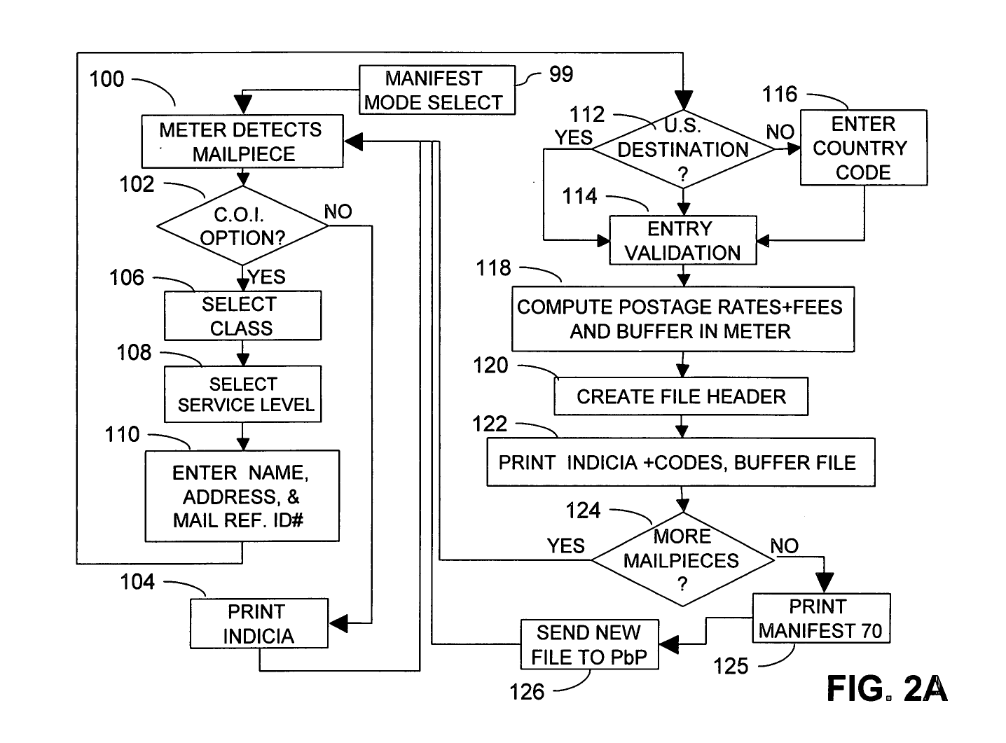

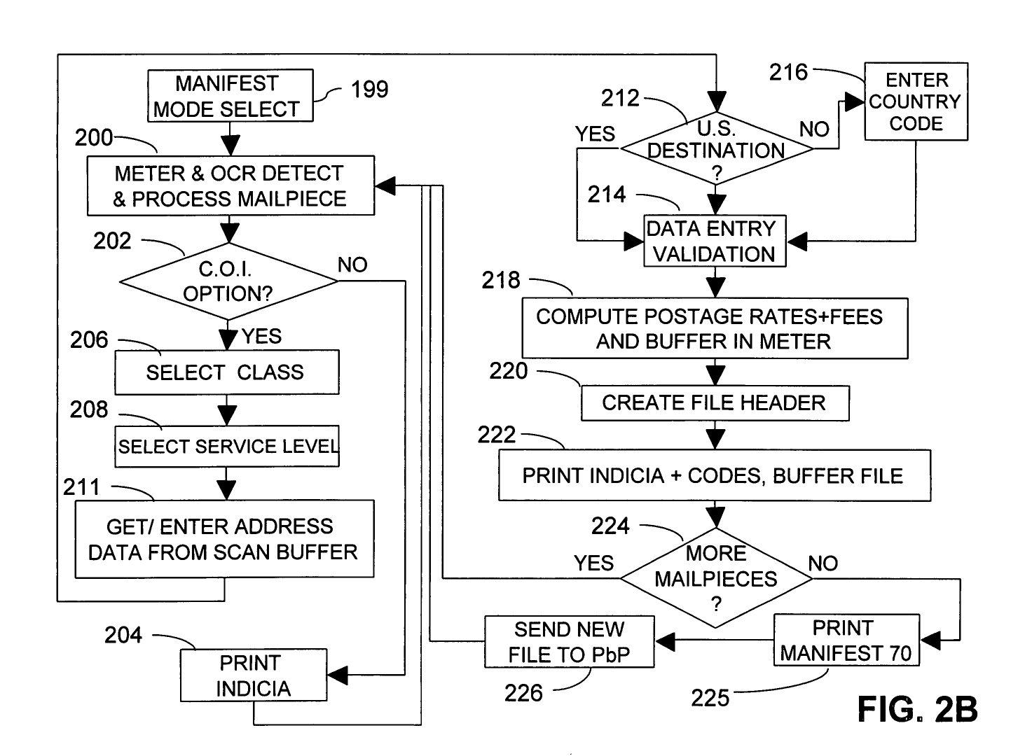

FIG. 2A is a flow chart describing an information gathering procedure at a postage meter for obtaining proof of mailing, i.e., certificate of induction, from a postage meter that uses manual recipient address entry. The procedure begins in block 99 where the operator of meter 12 selects the manifest mode. Then the procedure goes to block 100 where meter 12 detects the presence of mail piece 11. Then the procedure goes to decision block 102. In block 102, the mailer is asked whether or not the mailer wants the certificate of induction option, i.e., proof of mailing. If the mailer decides that the certificate of induction option is not desired, the procedure goes to block 104 where a normal postal indicium indicating payment of postage is printed on mail piece 11. If the mailer decides that the certificate of induction option is desired, the procedure goes to block 106 where the mailer is asked to select the class of mail, i.e., first class, priority mail, express mail, etc. After the mailer selects the class of mail, the procedure goes to block 108 where the mailer selects the service level, i.e., certified mail, delivery confirmation, insured mail, registered mail, signature confirmation, etc. After the mailer enters the service level, the procedure goes to block 110 where the mailer is asked to enter the recipient's name and address and the mailer's reference number, i.e., docket number. After the mailer enters the information in block 110, the procedure goes to decision block 112.

Decision block 112 asks the mailer if mail piece 11 is going to be mailed to a United States destination address. If block 112 determines that mail piece 11 is not going to be mailed to a United States destination address, the procedure goes to block 116 where the mailer is asked to enter the country code for the destination address of mail piece 11. If block 112 determines that mail piece 11 is going to be mailed to a United States destination address or the mailer has entered the country code in block 116, the procedure goes to block 114. At block 114, postage meter 12 validates all of the above entries provided by the mailer.

After all of the entries are validated, the procedure goes to block 118, where meter 12 computes the postage rates and service fees and stores them in a buffer of meter 12. Now the procedure goes to block 120 to create and store a header for the record regarding mail piece 11 in a buffer of meter 12. Then the procedure goes to block 122 and causes meter 12 to print a normal postal indicium and identification code 15 on mail piece 11. Now the procedure goes to decision block 124. Block 124 determines whether or not there are any more mail pieces. If block 124 determines there are additional mail pieces, the procedure goes back to the input of block 100. If block 124 determines there are no additional mail pieces, the procedure goes to block 125 where meter 12 prints manifest 70. Then the procedure goes to block 126. Block 126 sends the files to data center 21, and then the procedure goes back to block 100.

FIG. 2B is a flow chart describing an information gathering procedure at the postage meter for obtaining proof of mailing that uses optical character recipient address entry. The procedure begins in block 199 where the operator of meter 12 selects the manifest mode. Then the procedure goes to block 200 where meter 12 and optical character recognition device 27 (FIG. 1) detect the presence of mail piece 11. Then the procedure goes to decision block 202. In block 202, the mailer is asked whether or not the mailer wants the certificate of induction option, i.e., proof of mailing. If the mailer decides that the certificate of induction option is not desired, the procedure goes to block 204 where a normal postal indicia indicating payment of postage is printed on mail piece 11. If the mailer decides that the certificate of induction option is desired, the procedure goes to block 206 where the mailer is asked to select the class of mail, i.e., first class, priority mail, etc. After the mailer selects the class of mail, the procedure goes to block 208 where the mailer selects the service level, i.e., certified mail, delivery confirmation, insured mail, registered mail, signature confirmation, etc. After the mailer enters the service level, the procedure goes to block 211 where meter 12 obtains recipient's name and address and identification information by scanning the face of mail piece 11. Then the procedure goes to decision block 212.

Decision block 212 asks the meter if mail piece 11 is going to be mailed to a United States destination address. If block 212 determines that mail piece 11 is not going to be mailed to a United States destination address, the procedure goes to block 216 where the device 27 provides the information to enter the country code for the destination address of mail piece 11. If block 212 determines that mail piece 11 is going to be mailed to a United States destination address or the device 27 has provided the information to enter the country code in block 216, the procedure goes to block 214. At block 214, postage meter 12 validates all of the above entries provided by the device 27 and meter 12.

After all of the entries are validated, the procedure goes to block 218, where meter 12 computes the postage rates and service fees and stores them in a buffer of meter 12. Now the procedure goes to block 220 to create and store a header for the record regarding mail piece 11 in a buffer of meter 12. Then the procedure goes to block 222 and causes meter 12 to print a normal postal indicia and unique identification code 15 on mail piece 11. Now the procedure goes to decision block 224. Block 224 determines whether or not there are any more mail pieces. If block 224 determines there are additional mail pieces, the procedure goes back to the input of block 200. If block 224 determines there are no additional mail pieces, the procedure goes to block 225 where meter 12 prints manifest 70. Then the procedure goes to block 226. Block 226 sends the files to data center 21, and then the procedure goes back to block 200.

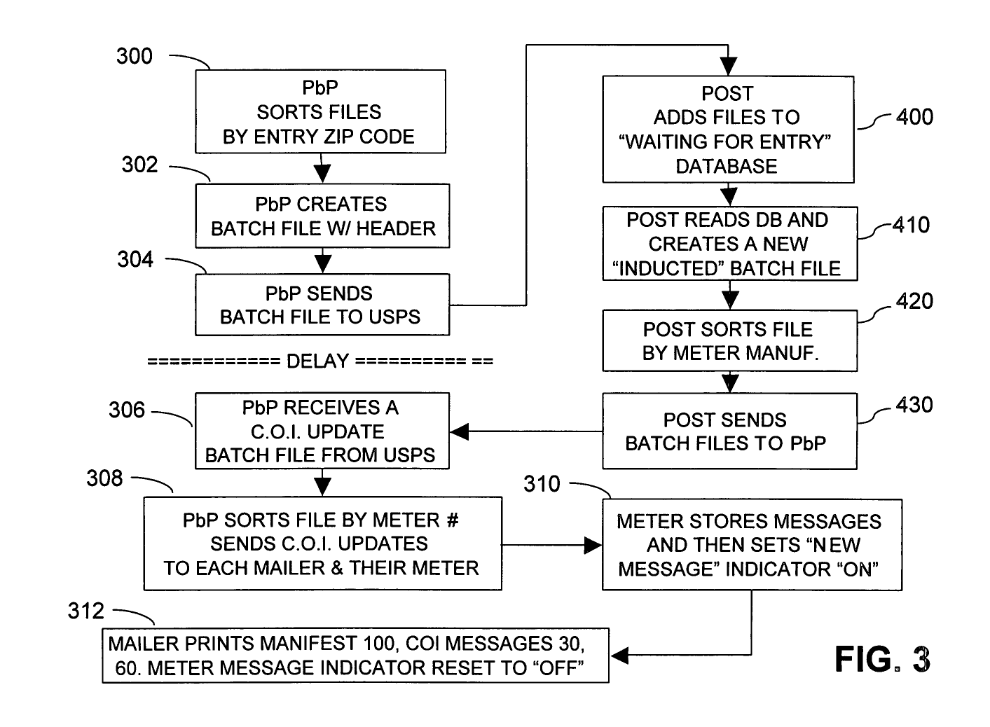

FIG. 3 is a flow chart describing the proof of mailing process with regard to Postage By Phone® data center 21. The process begins in block 300. In block 300, data center 21 sorts files by entry zip code. Then, in block 302, data center 21 creates a batch file with header. Now, in block 304, data center 21 sends the batch file to the USPS. At this point, in block 400, the post office adds files to “Waiting For Entry”. Now, in block 410, the post office creates a new batch file. Then, in block 420, the post office sorts the file by meter manufacture. Now, in block 430, the post office sends the batch files to data center 21. Then, in block 306, data center 21 receives a certificate of induction update batch file from the post office. Now, in block 308, data center 21 sorts the file by meter number and sends certificate of induction updates to both the mailer and the meter. Then, in block 310, meter 12 stores messages and sets the message indicator of messaging device 25 indicating that a message is present. Now in block 312, meter 12 prints certificates of induction 30 and/or certificates of non induction 60 and certificate of manifest induction 100 and then resets the message indicator to off.

FIG. 4A is a drawing of mail piece 11 of FIG. 1 in greater detail. Mail piece 11 has a recipient address field 35, a sender address field 36 that contains sender's name and address, and a field 37 that was printed by meter 12. Address field 35 contains recipient name and address 38, a postnet bar code 39, and unique number 15 in human-readable form, i.e., the serial number of meter 12, and the date and time meter 12 fixed indicia 41 to mail piece 11. Field 37 contains a postal indicium 41 that has a two-dimensional bar code 42 that may be encrypted and unique identification number 15 in the form of a bar code. United States Special Service Tracking Number 8, which is a unique identification code contains (1) a two-digit application identifier code; (2) a two-digit service type code; (3) a nine-digit D-U-N-S number; (4) an eight-digit sequence number; and (5) a one-digit check number. The application identifier code is used to denote that delivery confirmation service is required for the mail piece. The service type code is used to describe the product and service type, such as priority mail or standard mail (B). The D-U-N-S number is assigned to the mailer by the Dun & Bradstreet Corporation. The mail piece sequence number is assigned by the mailer to each mail piece. The check number is used to detect errors resulting from manual data entry or errors from data transmission.

Thus, meter 12, having serial number 004346212, affixed indicia 41 to mail piece 11 on Feb. 25, 2000, at 15:05000, and the sequence number for the mail piece addressed to Mr. A. Jones is 12345670.

FIG. 4B is a drawing of mail piece 11 of FIG. 4A addressed to a different recipient than that addressed in FIG. 4A. In FIG. 4B, mail piece 11 is addressed to Mr. A. Smith of 123 Main Street, Anytown, Conn. 12345 6711. Meter 12, having serial number 004346212, affixed indicia 41 to mail piece 11 on Feb. 25, 2000 at 15:05091, and the sequence number for the mail piece addressed to Mr. A. Smith is 12345678. Thus, 0.091 seconds elapsed between the affixing of indicia 41 to the mail piece addressed to Mr. A. Jones and the mail piece addressed to Mr. A. Smith.

FIG. 5A is a drawing of certificate of induction 30 indicating that a scanner of the post office has read unique identification code 15 on mail piece 11, which unique identification code 15 indicates that mail piece 11 has entered the delivery process. Certificate of induction 30 contains eagle 51, the fee for the certificate of induction 52, an indication that it has been paid 53, the recipient's name and address 54, a seal (round stamp) 55 of the entering post office that indicates the date of receipt of mail piece 11, the time 56 a scanner controlled by the post office read unique identification code 15, the serial number 58 of meter 12 indicating that a secure message was received from meter 12, the sender's name 57, and the mailer's docket number 59, which will remind the mailer to place certificate of induction in the correct file. It would be obvious to one skilled in the art that the sender's address may also be included, because the licensee's name and address of meter 12 is known to data center 21.

FIG. 5B is a drawing of a certificate of non-induction 60 indicating that a scanner of the post office has not read unique identification code 15 on mail piece 11 indicating that mail piece 11 has not entered the delivery process. Certificate of non-induction 60 contains eagle 61, the fee for the certificate of induction 62, an indication 63 that the fee for the certificate of induction has been refunded to meter 12, the recipient's name and address 64, a seal (round stamp) 65 of the entering post office that indicates the date that meter 12 notified data center 21 that a certificate of induction is being requested for mail piece 11, an indication 66 that a scanner controlled by the post office has not read unique identification code 15 or that there is no USPS record of reading identification code 15, the serial number 68 of meter 12, the sender's name 67, and the mailer's docket number 69, i.e., F-800, which will remind the mailer that mail piece 11 was not received by the post office, to place certificate of non-induction in the correct file, and to contact the recipient. Certificate of non-induction 60 will be prepared after a time interval determined by the post office data center 21 receives an indication that a certificate of induction was placed on mail piece 11 by meter 12. It would be obvious to one skilled in the art that the sender's name and address may also be included because the name and address of the licensee of meter 12 is known to data center 21.

FIG. 5C is a drawing of a certificate of manifest induction 100 indicating that a scanner of the post office has read manifest 70. Certificate of induction 100 contains eagle 101, the fee for the certificate of induction 102, an indication that it has been paid 103, the recipient's unique identification code 15, a seal (round stamp) 105 of the entering post office that indicates the date of receipt of manifest 100. Certificate of induction 100 also indicates the time 106 a scanner controlled by the post office reads unique identification code 15, that certificates of induction were requested for special service 110, and the total number of mail pieces 111. It would be obvious to one skilled in the art that the recipient's United States Special Service Tracking Numbers 8 may also be included with recipient's unique identification code 15.

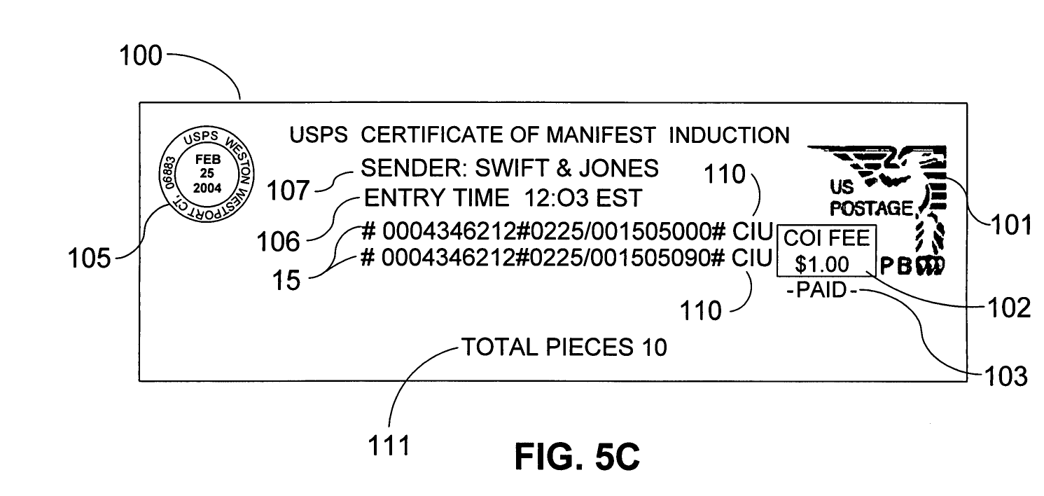

FIG. 6 is a drawing of a manifest 70. Manifest 70 contains an indication of the meter number 71, the sender 72, mail pieces unique identification codes 73, the service 74 requested, and the total number 75 of mail pieces 11 mentioned in manifest 70. Thus, the mailer requested certificates of induction for mail pieces 11 having unique codes 00043462120225/001505000 and 00043462120225/001505090, and the mailer requested that the mail piece 11 having unique code 00043462120225/001505051 be sent by certified mail. It would be obvious to one skilled in the art that the recipient's United States Special Service Tracking Numbers 8 may also be included with recipient's unique identification code 15.

FIG. 7 is a drawing of a plurality of mail pieces 11 being bound by a manifest 70. A rubber band 71 is used to keep mail pieces 11 together.

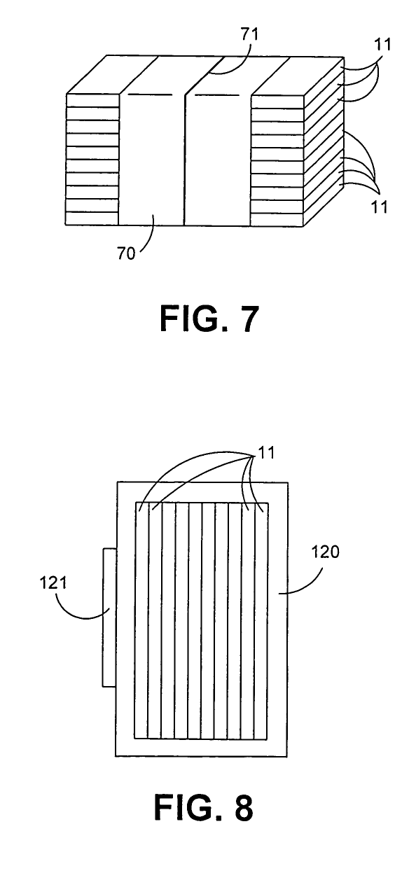

FIG. 8 is a drawing of a top view of a mail tray 120 containing mail pieces 11 and a manifest 50 (not shown) in pocket 121.

The above specification describes a new and improved method for providing proof of mailing of manifested mail pieces. It is realized that the above description may indicate to those skilled in the art additional ways in which the principles of this invention may be used without departing from the spirit. Therefore, it is intended that this invention be limited only by the scope of the appended claims.

1. A method for providing proof of mailing one or more mail pieces by a mailer, that are submitted by a mailer to a post office in a bundle or in a tray, the method comprises the steps of:
(a) placing an identification code on individual mail pieces with a postage meter at a location other than the post office, wherein the identification code identifies the sender of the mail piece and uniquely identifies individual mail pieces;
(b) placing the identification codes of the mail pieces in a manifest;
(c) transmitting the identification codes to a data center;
(d) depositing one or more mail pieces and the manifest with the post office at the post office or at a location other than the post office;
(e) attempting reading by the post office at a location other than the post office or at the post office the identification codes in the manifest;
(f) attempting reading by the post office at a location other than the post office or at the post office the identification code that is on one more mail pieces;
(g) retrieving the identification codes from the data center and the identification codes read by the post office; and
(h) notifying the postage meter that individual identification codes have been received by the data center and individual mail pieces identification codes have been read or not read by the post office.

2. The method claimed in claim 1, wherein the postage meter is an electronic postage meter.

3. The method claimed in claim 1, wherein the postage meter is a computer postage meter with a secure storage device.

4. The method claimed in claim 1, further including the step of:
printing at the postage meter a certificate indicating the identification code that has been read by the post office.

5. The method claimed in claim 4, further including the step of:
printing on the certificate the date the mail piece was read.

6. The method claimed in claim 5, further including the step of:
printing on the certificate the time the mail piece was read.

7. The method claimed in claim 1, further including the step of:
printing at the postage meter a certificate indicating that the identification code has not been read by the post office after a certain period of time has elapsed after the data center has received the identification code from the meter.

8. The method claimed in claim 1, wherein the identification code is a unique number.

9. The method claimed in claim 1, wherein the identification code comprises:
the serial number of the postage meter, and the date and time that the identification code was affixed to the mail piece.

10. The method claimed in claim 1, further including the steps of:
(a) printing a postal indicia on the mail piece for the payment of postage and any related postal fees; and
(b) charging the postage meter for printing the postal indicia.

11. The method claimed in claim 10, further including the step of:
refunding the postage meter account for part or all of the postage and fees that have been placed on mail pieces having identification codes that have not been read by the post office after a certain period of time has elapsed after the data center has received the identification code from the meter.

12. The method claimed in claim 1, further including the step of:
notifying the mailer via telephone that individual identification codes have been received by the data center, and individual mail pieces' identification codes have been read or not read by the post office.

13. The method claimed in claim 1, further including the step of:
notifying the mailer via e-mail that individual identification codes have been received by the data center, and individual mail pieces' identification codes have been read or not read by the post office.

14. The method claimed in claim 1, further including the step of:
notifying the mailer via facsimile that individual identification codes have been received by the data center, and individual mail pieces' identification codes have been read or not read by the post office.

15. The method claimed in claim 1, further including the steps of:
identifying the mailer's reference number of the document contained in the mail piece.

16. The method claimed in claim 15, further including:
(a) printing at the postage meter a certificate indicating that the identification code has not been read by the post office after a certain period of time has elapsed after the data center has received the identification code from the meter; and
(b) printing the mailer's reference number on the certificate of induction.

17. The method claimed in claim 16, further including the step of:
printing the mailer's name on the certificate of induction.

18. The method claimed in claim 15, further including the step of:
(a) printing at the postage meter a certificate indicating that the identification code has been read by the post office; and
(b) printing the mailer's reference number on the certificate of induction.

19. The method claimed in claim 18, further including the step of:
printing the mailer's name on the certificate of induction.

20. The method claimed in claim 1, wherein the identification code comprises: a United States Special Service Tracking Number.

21. The method claimed in claim 1, further including the step of:
printing at the postage meter a certificate indicating the identification codes from the manifest that has been read by the post office.

22. The method claimed in claim 21, further including the step of:
printing at the postage meter the date the manifest has been read by the post office.

23. The method claimed in claim 21, further including the step of:
printing at the postage meter the time the manifest has been read by the post office.
